(19) United States
(12) Patent Application Publication
(10) Pub. No.: US 2013/0227403 A1
(43) Pub. Date: Aug. 29, 2013

(54) Line Number Retention in Word Processor Applications

(71) Applicants: Lester S. Pierre, Valley Cottage, NY (US); Michal Trzcianowksi, Glendale, NY (US)

(72) Inventors: Lester S. Pierre, Valley Cottage, NY (US); Michal Trzcianowksi, Glendale, NY (US)

(73) Assignee: Wall Street Network, Inc.

(21) Appl. No.: 13/404,193

(22) Filed: Feb. 24, 2012

(51) Int. Cl. G06F 17/24

(52) U.S. Cl. 715/256

(57) ABSTRACT

A Line Number Retention feature for use in existing line number features of word processing applications to prevent automatic line re-numbering of a document. The Line Number Retention feature has the ability to allow users editing an existing document with line numbers to insert text and suppress the line numbering for the newly inserted text, preventing the automatic adjustment of the line numbers to the remaining original text of the document. The Line Number Retention allows the users to view the edited document with the same line numbers as the original document. The newly inserted text will not have line numbers, allowing the remaining text to retain their line numbers.

### BACKGROUND OF THE INVENTION

### Field of the Invention

Consumers use word processing applications for creating, formatting, editing, printing, etc. of documentation and other printable material. Today, word processors utilize a graphical user interface encompassing extravagant editing features and can produce combinations of text and images.

Of these editing features, a commonly used feature found in word processors is the ability to number each line of text that is created in a document. Line numbering features allow users of a word processor application to have line numbers run throughout the document consistently. More concise line numbering features may include the ability to have the line numbering start fresh on each page or following section breaks. Other word processors allow for the ability to suppress line numbers for particular paragraphs once the line numbering feature has been applied to the document. Word processors even allow the ability to count an inserted table as one line, an inserted figure as one line, and an inserted text box as one line if it conforms to certain criteria. However, with all the capabilities that line number features may provide, the ability to retain line numbers when editing a previously created document does not exist as a feature in word processors. Currently, when a user desiring to insert text into an existing document with line numbers does so, the line numbers automatically adjust to accommodate the new text. Entering new text automatically means new line numbers will be implemented. There is no means to turn off the line numbering feature for newly inserted text in word processing applications.

The present invention is a line number retention feature which is a feature that can be implemented in existing word processor applications. These word processor applications may include, but are not limited to, MICROSOFT OFFICE SUITE, including MICROSOFT WORD. The line number retention of the present invention has the ability to allow users editing an existing document with line numbers to insert text and not have the new text automatically have a line number, which would adjust the line numbers in the remainder of the document. This feature is especially beneficial to those users editing documents that require approval from some type of hierarchy prior to implementing the new text permanently; for example, the editing of laws, rules and regulations by an organization. These types of written federal code documents all contain line number and inserting new text during editing phases, which implements new line numbers creates confusion for those involved in these types of processes. With implementation of the present invention, those involved in this type of process can compare the original document with line numbers to the edited version of the same document. Line number retention allows the users to view the edited document with the same line numbers as the original document to prevent the inherent confusion. The newly inserted text will not have line numbers, allowing the original text to retain its line numbers.

### SUMMARY OF THE PRESENT INVENTION

The present invention relates generally to line numbering features of word processor applications which can create and edit documents, and more specifically to a Line Number Retention feature for word processing applications providing a solution whereby the user of such may edit documents containing line numbers without having any additions of new text automatically adjust the original line numbers, thereby retaining the line numbers in the document.

A primary object of the present invention is to provide a Line Number Retention feature for word processor applications where a user has the ability to insert new text into a document containing line numbers without automatically adjusting the line numbers.

Another object of the present invention is to provide a Line Number Retention feature for word processor applications where a user has the ability to preserve line numbers that already exist in the text.

Yet another object of the present invention is to provide a Line Number Retention feature for word processing applications where the user may implement the line number retention feature within a word processor application using the word processor application's pre-existing line number features.

Still yet another object of the present invention is to provide a Line Number Retention feature for word processing applications where the user may implement a line number retention feature within a word processor application using the word processor application's pre-existing document formatting features.

Another object of the present invention is to provide a Line Number Retention feature for word processing applications for use by users groups and organizations utilizing a document editing process requiring line number retention for presentation of changes.

The present invention overcomes the shortcomings of the prior art by providing a means for retaining line numbers while editing text in a document using a word processor application. Nowhere in the prior art exists a Line Number Retention feature having the ability to retain original line numbers in a document when adding new text within the document. Once implemented, this Line Number Retention feature of the present invention gives the user the ability to add text without automatically adjusting the line numbers. The newly added text will not contain line numbers, thus allowing the original line numbers to remain intact. The present invention gives the user the ability to eliminate confusion among different document versioning by allowing the user to retain line numbers across all edited versions of the original document, which is a requirement in a variety of processes for a variety of user groups and organizations.

The foregoing and other objects and advantages will appear from the description to follow. In the description, reference is made to the accompanying drawings, which forms a part hereof, and in which is shown by way of illustration of specific embodiments in which the invention may be practiced. These embodiments will be described in sufficient detail to enable those skilled in the art to practice the invention, and it is to be understood that other embodiments may be utilized and that structural changes may be made without departing from the scope of the present invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a screen shot illustrating one example of the basic line number feature found in word processing applications;

FIG. 2 is a screen shot illustrating one example of the line number feature as adjusted when new text is inserted in word processing applications;

FIG. 3 is a screen shot illustrating one example of the basic line number feature of starting new line numbers on each page found in word processing applications;

FIG. 4 is a screen shot illustrating one example of the basic line number feature starting of new line numbers on each page as adjusted when new text is inserted in a document in word processing applications;

FIG. 5 is a flow diagram illustrating one example of how the line number retention can be implemented in existing line numbering features of word processing applications; and

FIG. 6 is a screen shot illustrating one example of the line number retention feature of the present invention retaining line numbers when new text is inserted in a document.

### DETAILED DESCRIPTION OF THE PREFERRED EMBODIMENT

The following discussion describes in detail one embodiment of the invention (and several variations of the embodiment). This discussion should not be construed, however, as limiting the invention to those particular embodiments; practitioners skilled in the art will recognize numerous other embodiments as well. For definitions of the complete scope of the invention, the reader is directed to the appended claims.

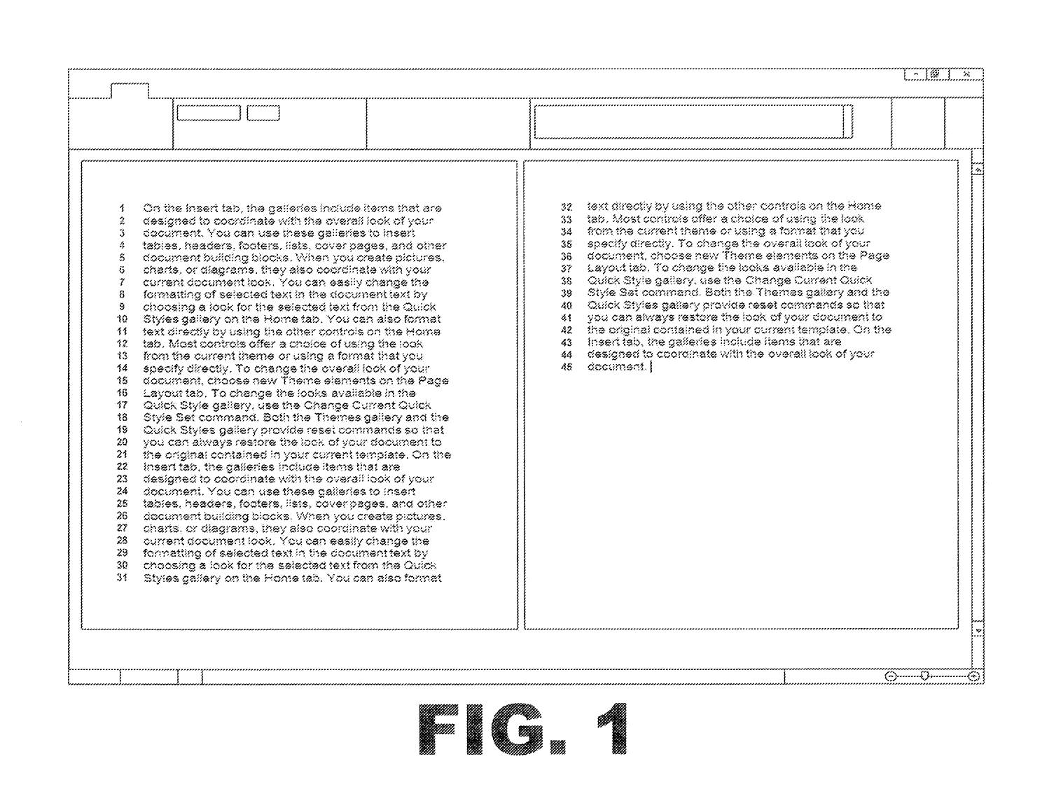

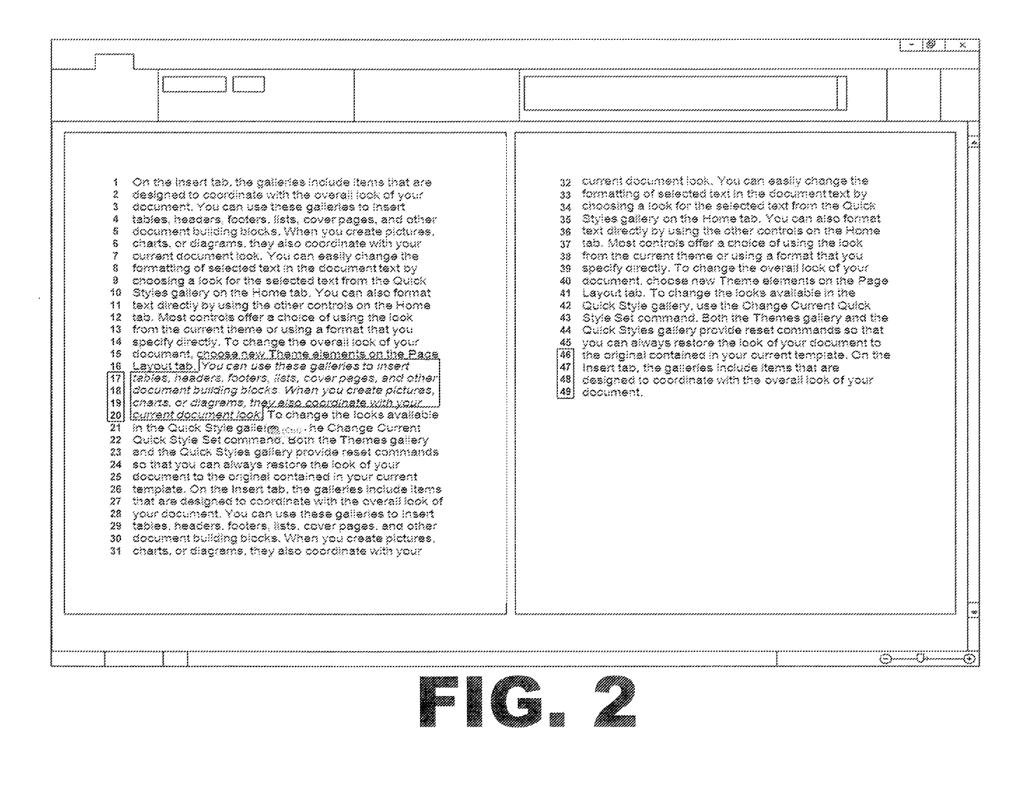

FIG. 1 is a screen shot illustrating one example of the basic line number feature found in word processing applications. FIG. 2 is a screen shot illustrating one example of the line number feature as adjusted when new text is inserted in word processing applications. FIG. 1 shows each line of a document numbered in consecutive order and continuing on each page of the document, which is a feature found in all word processing applications. FIG. 2 shows new text inserted at line 16 of the document, and the word processor's automatic adjustment of the line numbers to create new lines 16-20 and changing the line number of the remaining original lines of the document. This change to the original line numbers when the document is edited creates confusion when the document is being reviewed and contradictory to several organizations' editing process.

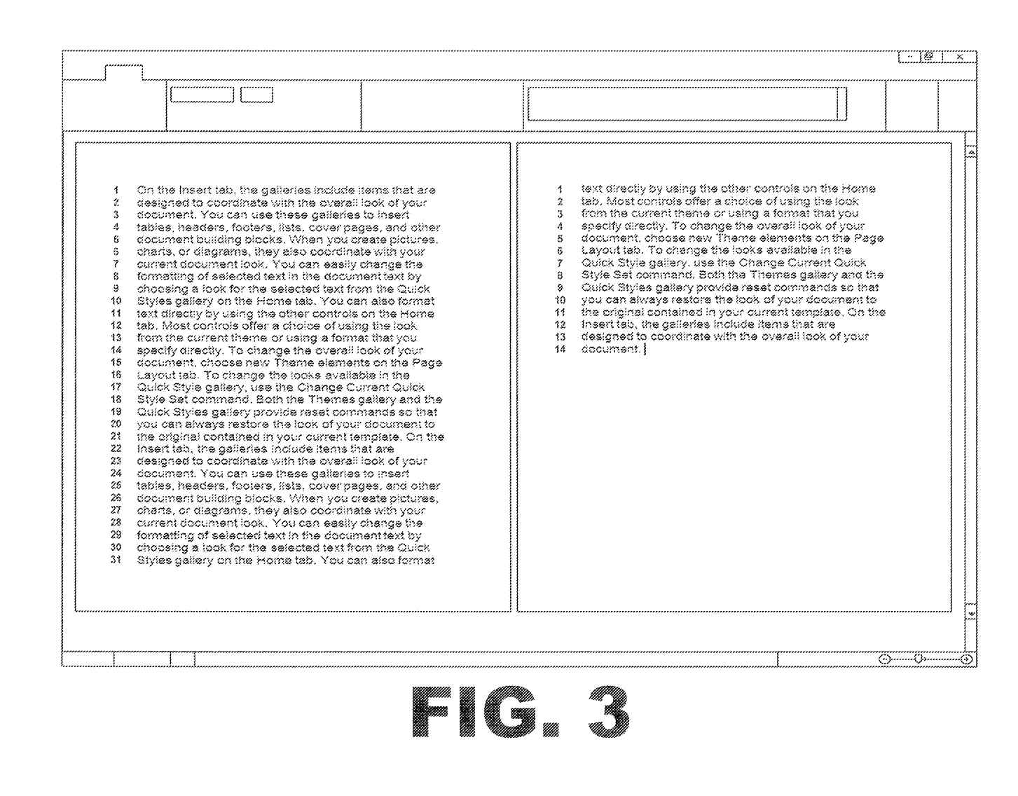

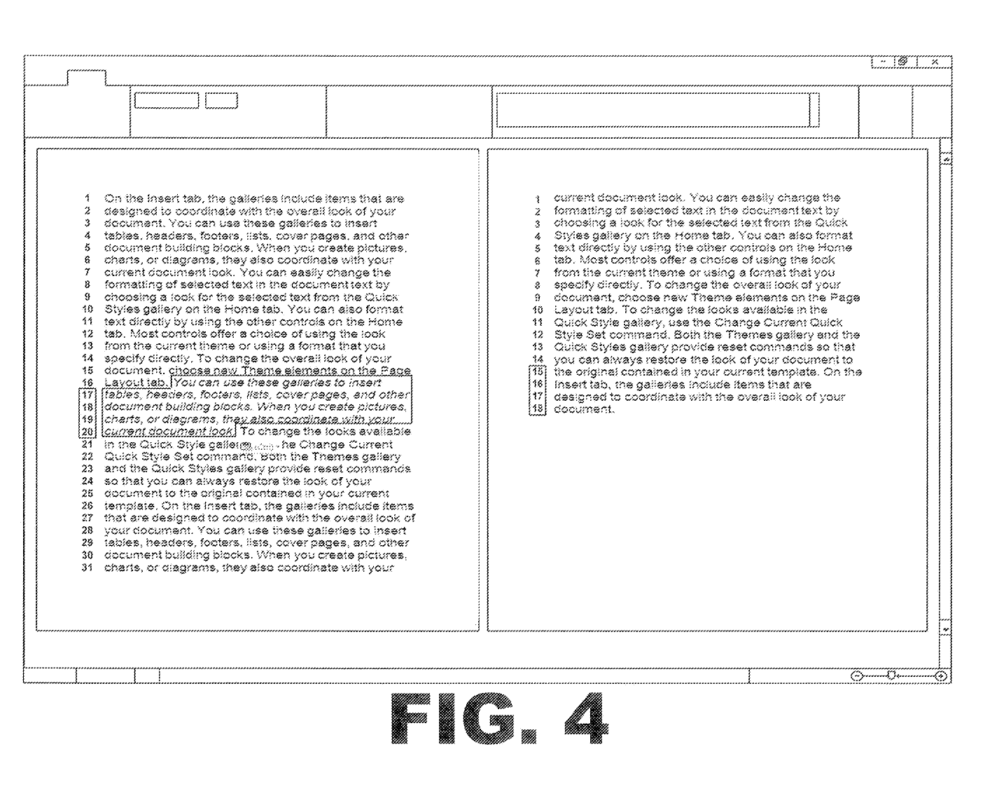

FIG. 3 is a screen shot illustrating one example of the basic line number feature of starting new line numbers on each page found in word processing applications. FIG. 4 is a screen shot illustrating one example of the basic line number feature of starting new line numbers on each page as adjusted when new text is inserted in a document in word processing applications. FIG. 3 shows a document which has implemented the feature of starting each page of a document with a fresh set of line numbers. FIG. 4 shows new text inserted at line 16 of the document, and the word processor's automatic adjustment of the line numbers to create new lines 16-20 and again changing the line numbers of the remaining original lines of the document. The present invention is designed to allow a user to insert new text in any portion, paragraph, or section of a document and retaining the original line numbers by allowing the suppression of line numbers for any new, inserted text.

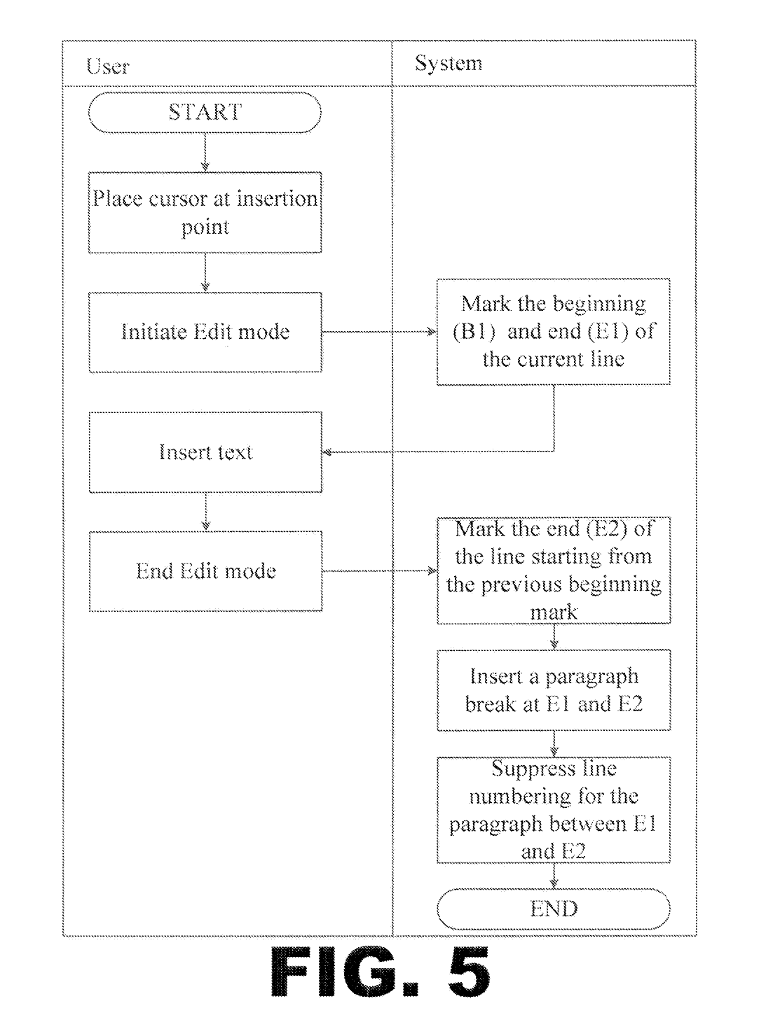

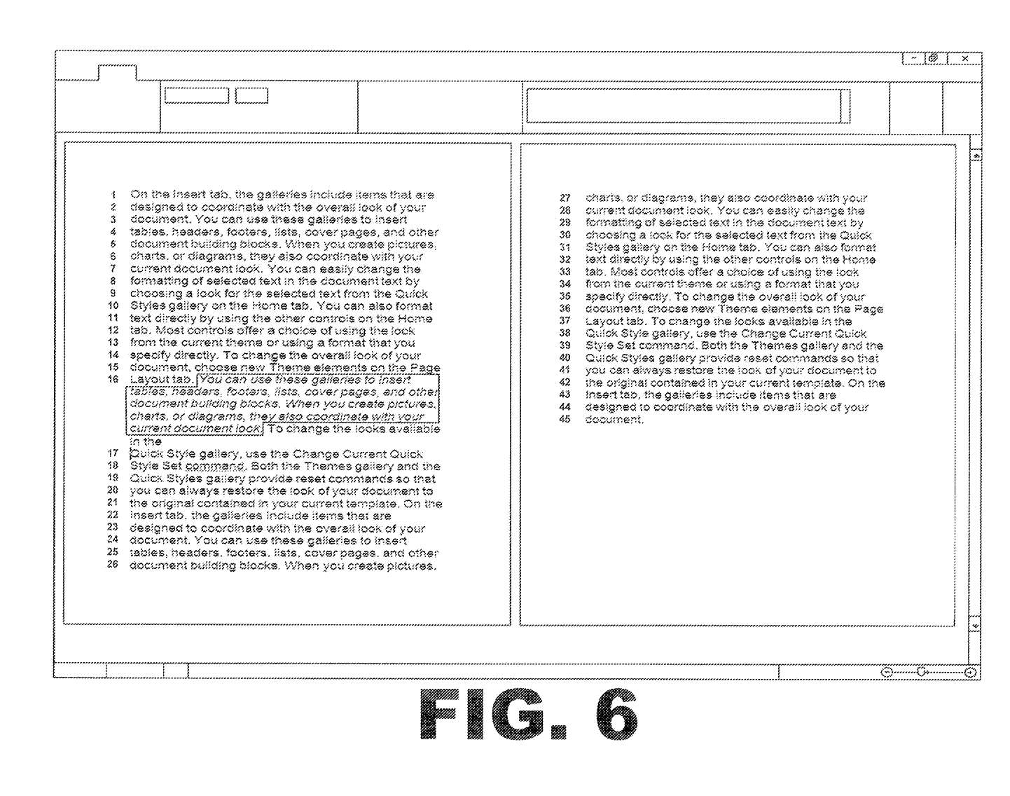

FIG. 5 is a flow diagram illustrating one example of how the line number retention feature of the present invention can be implemented in word processing applications. The precondition of implementing the line number retention feature is utilizing a document containing line numbers. In order for the user to accomplish line number retention as new text is being inserted in a document, the user must first place the cursor where the insertion point of the new text will be. The user will then initiate the Edit Mode. The Edit Mode will interact with the system, in this case a word processor, to mark the beginning, B1, and end, E1, of the current line in which the user desires to insert text. The Edit Mode may be configured in the word processor using source code to find the end of the current line. The source code that creates the Edit Mode can be created and implemented in a variety of ways, including, but not limited to, using a macro, shortcut or add-in which has been configured through the word processor. Once the Edit Mode has been initiated by the user, the user next inserts the new text and finally ends the Edit Mode. At this point, the system will bookmark the end of the line, E2, starting from the previous beginning, B1, bookmark and inserts a paragraph break at E1 and E2. The reason behind the bookmark of E1 is to allow for the text to move down and allows for the system to know where to place the second paragraph break. Finally, the system will suppress the line numbering for the paragraph between E1 and E2. This will cause the inserted text to refrain from having line numbers and allow the original text to retain its line numbers. The result is the inserted lines and text wrapped around from the lines where text was inserted will appear without line numbers, as seen in FIG. 6. When the paragraph marks are implemented, the bookmarks are automatically removed. The purpose of the replacement of the bookmarks with paragraph marks is to ensure the document does not contain extra marks; the substitution of paragraph marks ensures a clean copy.

In order for the line number retention to be implemented successfully, two algorithms must be applied for the system's (word processor's) starting of the Edit Mode and ending of the Edit Mode, as described above.

The algorithm for starting the Edit Mode includes:

1. inserting a Start Line bookmark at the beginning of the line where the user has placed the cursor; and

2. inserting an End Line bookmark at the end of the line where the user has placed the cursor.

The algorithm for ending the Edit Mode includes:

1. inserting a New End Line bookmark at the end of the line that starts with the Start Line bookmark;

2. inserting a paragraph break after the End Line bookmark;

3. inserting a paragraph break after the New End Line bookmark; and

4. suppressing the line numbering for paragraphs between the End Line bookmark and the New End Line bookmark.

The algorithms may be implemented into the system as source code using a variety of methods including, but not limited to, implementing the algorithm through a macro, add-in, shortcut, button or menu option in the word processor application.

FIG. 6 is a screen shot illustrating one example of the line number retention feature of the present invention retaining line numbers when new text is inserted in a document. Shown is a document where new text was inserted at line 16. The new text does not automatically receive line numbers, and the original line numbers of the original text of the document remains intact. Once the newly inserted text has been approved and/or accepted by the hierarchy, the line numbers may be adjusted to incorporate the new text and adjusted line numbers when deemed appropriate by the user or organization utilizing the present invention.

What is claimed is new and desired to be protected by Letters Patent and is set forth in the appended claims:

1. A Line Number Retention feature for word processor applications comprising a means for retaining line numbers in a word processor.

2. The Line Number Retention feature for word processor applications according to claim 1, further comprising a means for implementing said line number feature within a word processor application using the word processor's pre-existing line numbering features.

3. The Line Number Retention feature for word processor applications according to claim 1, further comprising a means for implementing said line number features within a word processor application using the word processor's pre-existing document formatting features.

4. The Line Number Retention feature for word processor applications according to claim 1, wherein said means comprises configuring an Edit Mode within the word processor.

5. The Line Number Retention feature for word processor applications according to claim 4, wherein said Edit Mode comprises a means for suppressing line numbers for new text.

6. The Line Number Retention feature for word processor applications according to claim 5, wherein said Edit Mode further comprises a means for retaining line numbers for original text.

7. The Line Number Retention feature for word processor applications according to claim 1, wherein said means comprises
a. placing the word processor cursor where text is to be edited;
b. inserting a start line mark at the beginning of a line where the text is to be edited;
c. inserting an end line mark at the end of the line where the text is to be edited;
d. inserting a new end line mark at the end of the line that starts with the start line mark;
e. inserting a break after the end line mark;
f. inserting a break after the new end line mark; and
g. suppressing the line numbering for paragraphs between the end line mark and the new end line mark.
